(19) United States
(12) Patent Application Publication
(10) Pub. No.: US 2008/0275768 A1
(43) Pub. Date: Nov. 6, 2008

(54) METHODS AND APPARATUS FOR PROVIDING A COUPON AT AN AUTOMATED TELLER MACHINE

(76) Inventors: Jared Krasney Berman, Pepper Pike, OH (US); Benjamin Matthew Baron, Denville, NJ (US)

Correspondence Address: BELL, BOYD & LLOYD, LLP, P.O. Box 1135, CHICAGO, IL, 60690, US

(21) Appl. No.: 11/744,604

(22) Filed: May 4, 2007

(51) Int. Cl. G06Q 30/00

(52) U.S. Cl. 705/14

(57) ABSTRACT

The present disclosure provides methods and apparatus for providing a coupon at an automated teller machine. In general, a user of the disclosed system performs a financial transaction at an automated teller machine (ATM). In addition, the ATM displays and prints one or more coupons for the user. Preferably, the coupon(s) are selected from a database of coupons based on the geographic location of the ATM (e.g., a nearby restaurant). Preferably, the coupon includes directions to the associated store and/or directions within the associated store. For example, a map with an overlaid route and/or text-based directions from the ATM to the store may be printed on the coupon. In addition to geography, coupon selection may be based on one or more other variables such as the ATM transaction type, the ATM transaction amount, the person's age, the person's sex, the person's previous purchases, etc. Coupon providers may be charged in a variety of different ways. For example, coupon providers may be charged for each time a coupon is displayed, each time a coupon is printed, and/or each time a coupon is redeemed.

### TECHNICAL FIELD

The present application relates in general to advertising and more specifically to methods and apparatus for providing a coupon at an automated teller machine.

### BACKGROUND

Advertisers frequently use coupons as a way to drive traffic to a retail location. For example, coupons may be included in mailers or newspapers. However, most coupons are not redeemed, because many people find carrying the coupon until it is needed cumbersome. A system is needed to provide coupons to customers closer in time to when the coupon is needed and closer in proximity to where the coupon is redeemed.

### SUMMARY

The present disclosure provides methods and apparatus for providing a coupon at an automated teller machine (ATM). In general, the improved ATM displays and prints one or more coupons for the user. Preferably, the coupon(s) are selected from a database of coupons based on the geographic location of the ATM. For example, the ATM may offer a coupon for a nearby restaurant. In some instances, ATMs are located inside a store. In such an instance, coupon selection may be based on products that are carried by that store.

In an embodiment, the coupon includes directions to the associated store and/or directions within the associated store. For example, a map with an overlaid route and/or text-based directions from the ATM to the store may be printed on the back of the coupon. In addition, a video based “walk through” to the store and/or within the store may be displayed on the ATM screen. For ATMs located within a store, floor layouts and aisle numbers preferably replace street maps and street names.

In addition to geography, coupon selection may be based on one or more other variables such as the ATM transaction type, the ATM transaction amount, the person's age, the person's sex, the person's previous purchases, etc. In one embodiment, the user is given a plurality of coupon type choices. For example, the user may choose by store name (e.g., Starbucks, Sears, etc.), by store type (e.g., coffee shop, department store, etc.), and/or by product type (e.g., beverages, tools, etc.). Preferably, the database of coupons may be electronically updated (e.g., via the Internet).

Coupon providers (e.g., store owners, product manufacturers, etc.) may be charged in a variety of different ways. For example, coupon providers may be charged for each time a coupon is displayed, each time a coupon is printed, and/or each time a coupon is redeemed. In an embodiment, coupon providers may be charged at various rates depending on certain coupon placement variables. Alternatively, coupon providers may bid for certain types of coupon placement. For example, a relatively higher rate may apply when a relatively higher withdrawal is made from the ATM, and/or certain geographic locations may command higher rates than other geographic locations.

### BRIEF DESCRIPTION OF THE FIGURES

FIG. 1 is a high level block diagram of an example communications system.

FIG. 2 is a more detailed block diagram showing one example of a computing device.

FIG. 3 is a first portion of a flowchart showing one example of a system for providing a coupon at an automated teller machine.

FIG. 4 is a second portion of the flowchart showing one example of the system for providing a coupon at an automated teller machine.

FIG. 5 is a screen shot showing an example ATM welcome screen.

FIG. 6 is a screen shot showing an example PIN entry screen.

FIG. 7 is a screen shot showing an example ATM transaction screen.

FIG. 8 is a screen shot showing an example category selection screen.

FIG. 9 is a screen shot showing an example coupon selection screen.

FIG. 10 is a screen shot showing an example directions screen.

FIG. 11 is a block diagram showing an example printed coupon.

### DETAILED DESCRIPTION

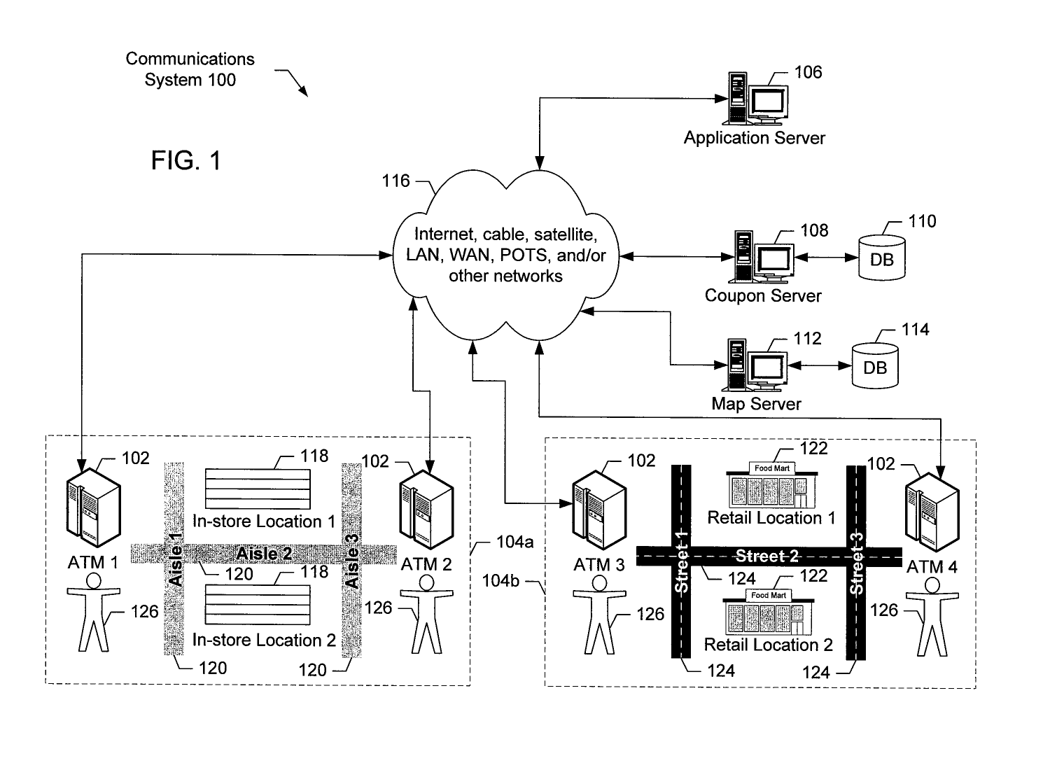

The present system is most readily realized in a network communications system. A high level block diagram of an exemplary network communications system 100 is illustrated in FIG. 1. The illustrated system 100 includes one or more automated teller machines (ATMs) 102 in one or more geographical areas 104, one or more application servers 106, one or more coupon servers 108 connected to one or more coupon databases 110, one or more program map servers 112 connected to one or more map databases 114. Each of these devices may communicate with each other via a connection to one or more communications channels 116. The communications channels 116 may be any suitable communications channels 116 such as the Internet, cable, satellite, local area network, wide area networks, telephone networks, wireless networks, etc. It will be appreciated that any of the devices described herein may be directly connected to each other and/or connected over one or more networks.

Geographical areas 104 may include indoor geographical areas 104a and/or outdoor geographical areas 104b. Indoor geographical areas preferably include one or more in-store locations 118 and one or more aisles 120. For example, in-store locations 118 may include stores within a mall and/or departments within a store, such as sporting goods, men's clothing, second floor, etc., and/or specific locations, such as shelf numbers. These in-store locations 118 are preferably located in or near certain aisles 120, such as aisle 1, the frozen food aisle, the C section, etc. Outdoor geographical areas 104 preferably include one or more retail locations 122 and one or more streets 124. For example, retail locations 122 may include specific restaurants, convenience stores, clothing stores, etc. These retail locations 122 are preferably located in or near certain streets 124, such as at 123 State Street, the intersection of State and Madison, on Madison between Clark and Dearborn, etc.

One server 106, 108, 112 may interact with a large number of ATMs 102. Accordingly, each server 106, 108, 112 is typically a high end computing device with a large storage capacity, one or more fast microprocessors, and one or more high speed network connections. Conversely, relative to a server 106, 108, 112, each ATM 102 typically includes less storage capacity, less processing power, and a slower network connection.

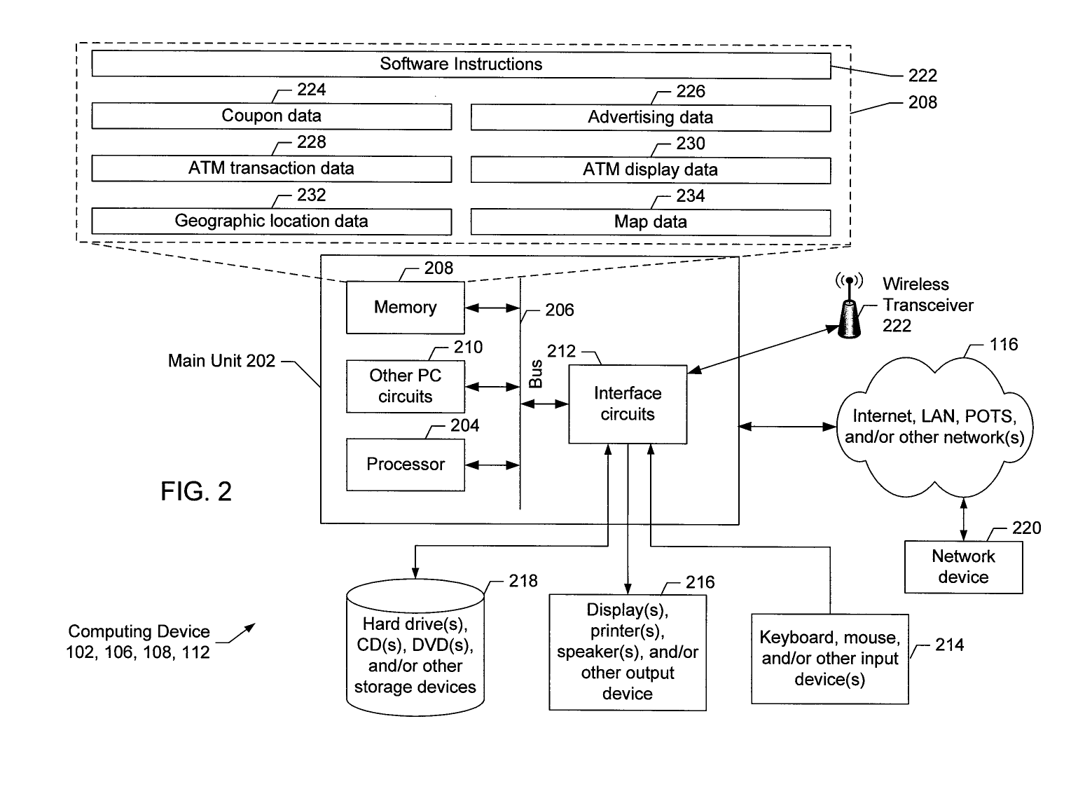

A detailed block diagram of an example computing device 102, 106, 108, 112 is illustrated in FIG. 2. Each computing device 102, 106, 108, 112 may include a server, a personal computer (PC), an ATM, a personal digital assistant (PDA), a mobile telephone and/or any other suitable computing device. Each computing device 102, 106, 108, 112 preferably includes a main unit 202 which preferably includes one or more processors 204 electrically coupled by an address/data |bus| 206 to one or more memory devices 208, other computer circuitry 210, and one or more interface circuits 212. The processor 204 may be any suitable microprocessor.

The memory 208 preferably includes volatile memory and non-volatile memory. Preferably, the memory 208 and/or another storage device 218 stores software instructions 222 that interact with the other devices in the system 100 as described herein. These software instructions 222 may be executed by the processor 204 in any suitable manner. The memory 208 and/or another storage device 218 may also store one or more data structures 224, 226, 228, 230, 232, 234, such as digital data indicative of documents, files, programs, web pages, etc. retrieved from another computing device 102, 106, 108, 112 and/or loaded via an input device 214.

The example data structures 224, 226, 228, 230, 232, 234 shown in FIG. 2 include coupon data 224, advertising data 226, ATM transaction data 228, ATM display data 230, geographic location data 232, and map data 234. Preferably, coupon data 224 is used to display and/or print coupons as described in detail below. For example, coupon data 224 may include coupon text, coupon graphics, coupon amounts, coupon codes, expiration dates, store specials, etc. Preferably, advertising data 226 is used to display and/or print advertisements as described in detail below. For example, advertising data 226 may include advertising text, advertising graphics, advertising animations, advertising video, advertising audio, etc. Preferably, ATM transaction data 228 is used to perform one or more financial transactions. For example, ATM transaction data 228 may include account numbers, personal identification numbers (PINs), dollar amounts, transaction types, transaction times, approval codes, etc. Preferably, ATM display data 230 is used to display user interface screens for an ATM 102 as described in detail below. For example, ATM display data 230 may include ATM text, ATM graphics, dollar amounts, transaction types, transaction times, etc. Preferably, geographic location data 232 is used to identify a geographic location associated with a particular ATM 102. For example, geographic location data 232 may include Global Positioning System (GPS) data, latitudes, longitudes zip codes, area codes, cities, states, streets, addresses, etc. Preferably, map data 234 is used to direct a user 126 from an ATM 102 to a retail location 122 and/or an in-store location 118. For example, map data 234 may include map text, map graphics, map animation, map video, map audio, etc.

It will be appreciated that many other data fields and records may be stored in the data structures 224, 226, 228, 230, 232, 234 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), a touch screen, or any other type of display. The display 216 generates visual displays of data generated during operation of the computing device 102, 106, 108, 112. For example, the display 216 may be used by an ATM 102 to display coupon data 224 received from the coupon server 108. The visual displays may include prompts for human input, text, graphics, video, calculated values, data, etc. For example, an ATM 102 may ask a user 126 if he/she would like to make a donation to a charity.

One or more storage devices 218 may also be connected to the main unit 202 via the interface circuit 212. For example, a hard drive, CD drive, DVD drive, flash memory drive, and/or other storage devices may be connected to the main unit 202. The storage devices 218 may store any type of data used by the computing device 102, 106, 108, 112.

Each computing device 102, 106, 108, 112 may also exchange data with other computing devices 102, 106, 108, 112 and/or other network devices 220 via a connection to the communication channel(s) 116. The communication channel(s) 116 may be any type of network connection, such as an Ethernet connection, WiFi, WiMax, digital subscriber line (DSL), telephone line, coaxial cable, etc. Data may be passed across the communication channel(s) 116 using encryption built into the computing devices 102, 106, 108, 112.

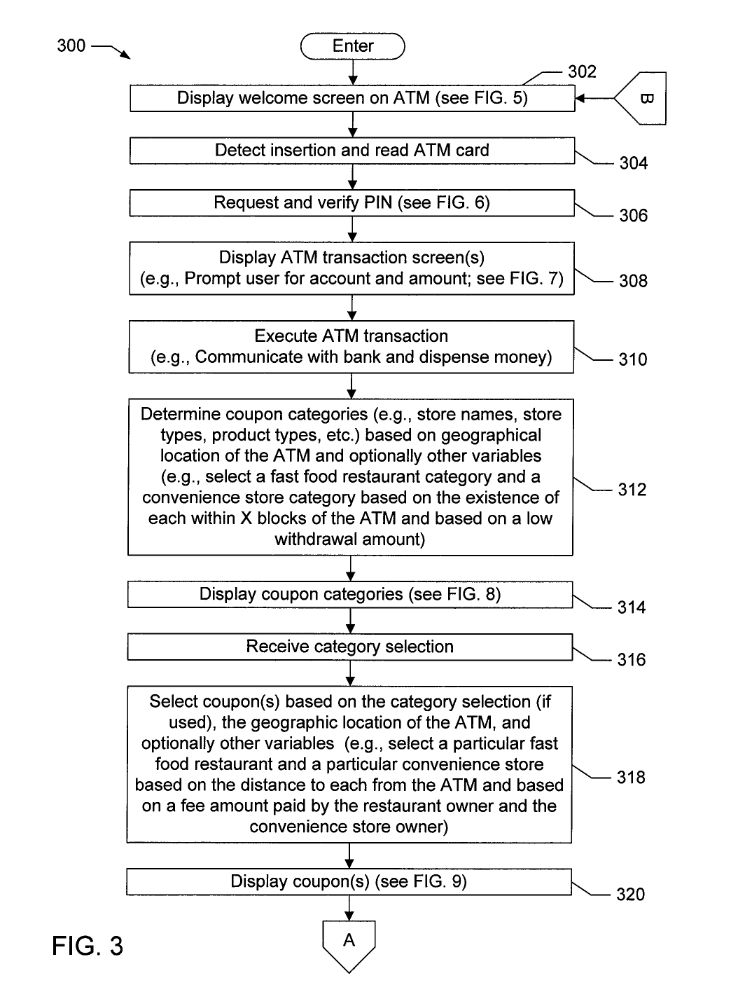

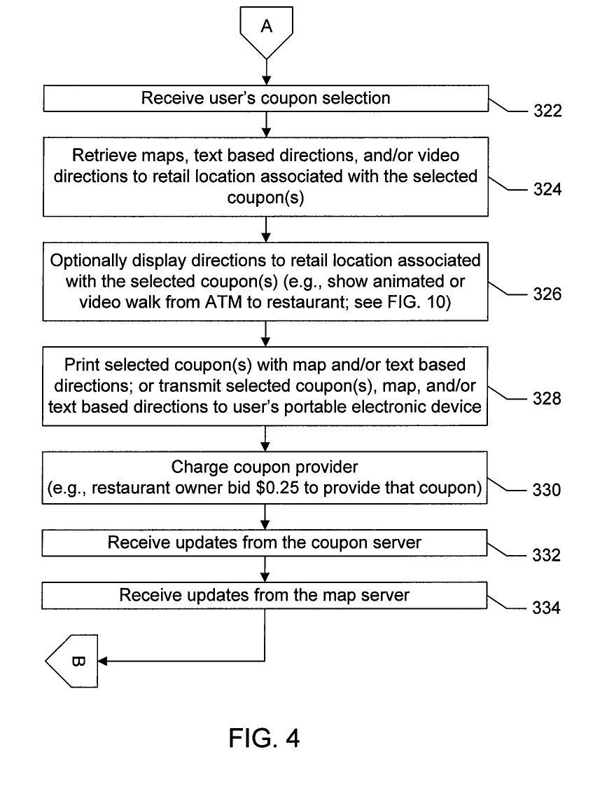

A flowchart of an example process 300 for providing a coupon at an automated teller machine is presented in FIG. 3 and FIG. 4. Preferably, the process 300 is embodied in one or more software programs 222 which is stored in one or more memories 208, 218 and executed by one or more processors 204. Although the process 300 is described with reference to the flowchart illustrated in FIG. 3 and FIG. 4, it will be appreciated that many other methods of performing the acts associated with process 300 may be used. For example, the order of many of the steps may be changed, and some of the steps described may be optional.

In general, a user of the disclosed system performs a financial transaction at an automated teller machine (ATM). In addition, the ATM displays and prints one or more coupons for the user. Preferably, the coupon(s) are selected from a database of coupons based on the geographic location of the ATM (e.g., a nearby restaurant). Preferably, the coupon includes directions to the associated store and/or directions within the associated store. For example, a map with an overlaid route and/or text-based directions from the ATM to the store may be printed on the coupon. In addition to geography, coupon selection may be based on one or more other variables such as the ATM transaction type, the ATM transaction amount, the person's age, the person's sex, the person's previous purchases, etc. Coupon providers may be charged in a variety of different ways. For example, coupon providers may be charged for each time a coupon is displayed, each time a coupon is printed, and/or each time a coupon is redeemed.

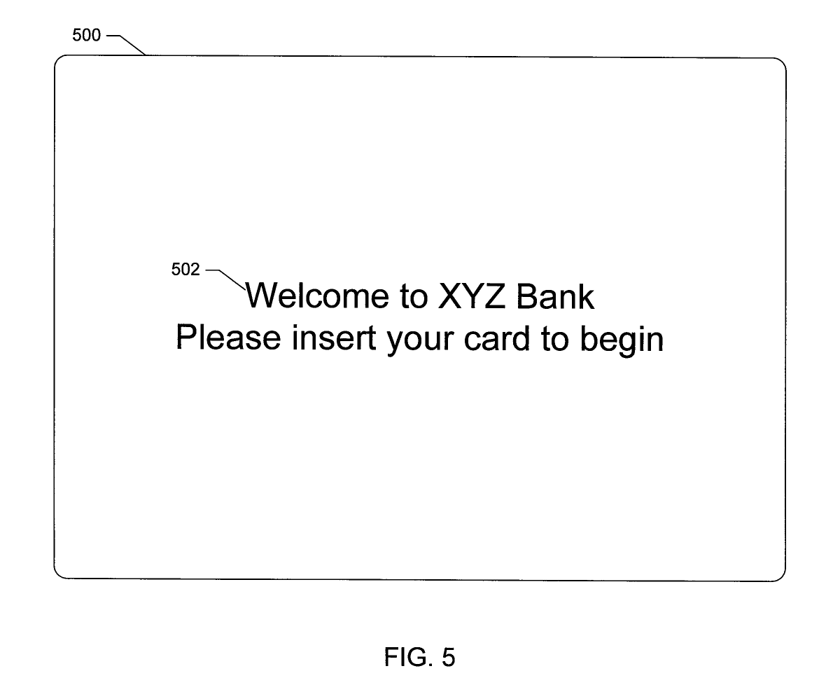

The example process 300 begins with an ATM 102 displaying a welcome screen (block 302). A screen shot of an example ATM welcome screen 500 is illustrated in FIG. 5. In this example, the welcome screen 500 includes a text message 502. It will be appreciated that other data may be displayed on the ATM welcome screen 500. For example, advertisements and/or coupons may be displayed on the ATM welcome screen 500. Preferably, the ATM welcome screen and any advertisements and/or coupons displayed are based on the coupon data 224, the advertising data 226, the ATM display data 230, the geographic location data 232, and/or the map data 234 described above. For example, an advertisement for a television show may be displayed and a reminder showing the channel and time may be printed.

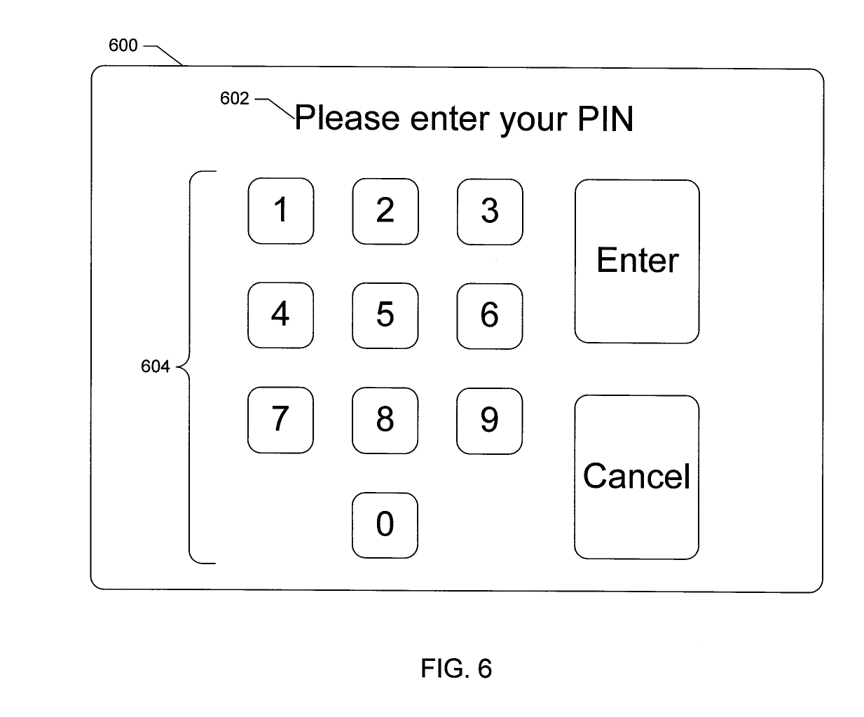

Once the ATM 102 detects an insertion of an ATM card and reads the data encoded on the ATM card (block 304), the ATM 102 requests a personal identification number (PIN) from the user 126 and verifies that the data from the ATM card corresponds to the PIN entered by the user 126 (block 306). A screen shot of an example PIN entry screen 600 is illustrated in FIG. 6. In this example, the PIN entry screen 600 includes a text message 602 and a touch screen keypad 604. The user 126 may enter his/her PIN using the touch screen keypad 604 and/or a physical keypad in a well known manner. It will be appreciated that any suitable substitute for the ATM card and/or the PIN may be used. For example, instead of an ATM card, the user 126 may have a wireless device capable of transmitting the encoded data. Similarly, the PIN may be entered via a wireless device and/or some other user identifier may be used, such as a fingerprint.

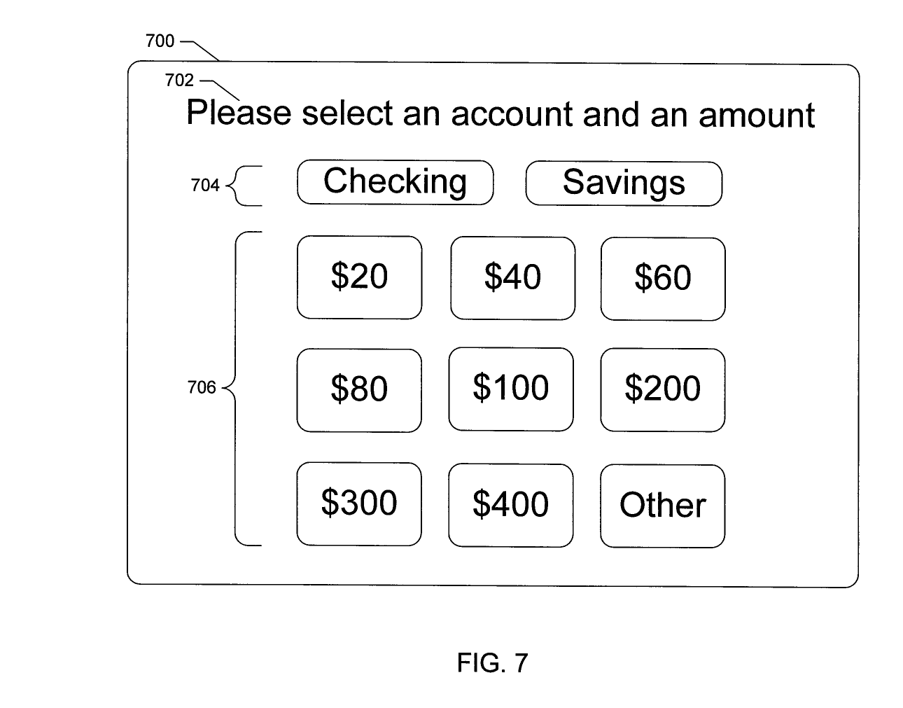

If the data from the ATM card corresponds to the PIN entered by the user 126, the ATM displays one or more transaction screens (block 308). A screen shot of an example ATM transaction screen 700 is illustrated in FIG. 7. In this example, the ATM transaction screen 700 includes a text message 702, an account selection area 704, and an amount selection area 706. The user 126 may select an account (e.g., checking) and an amount (e.g., $100) to withdraw funds from his/her account. It will be appreciated that any suitable method of indicating accounts, amounts, and/or other data may be used. In addition, any suitable ATM transaction (e.g., deposit, withdraw, transfer, check balance, etc.) and/or any number of ATM transaction screens may be used.

Once the user 126 provides his/her transaction selections and/or transaction data, the ATM 102 executes the ATM transaction (block 310). For example, if the user 126 is withdrawing funds, the ATM 102 may communicate with a bank or other suitable financial institution for approval and dispense the requested funds if approved.

At some point during the process 300, the ATM 102, the application server 106, the coupon server 108, and/or the map server 112 may determine a plurality of coupon categories based on the geographical area 104 associated with the ATM 102 (block 312). For example, the ATM 102 may query the map database 114 for a list of retail locations in and/or near the geographical area 104 associated with the ATM 102. This list of retail locations may include store names (e.g., Starbucks, Sears, etc.), store types (e.g., coffee shop, department store, etc.), product types (e.g., beverages, tools, etc.), geographical locations, distances from the ATM 102, etc.

The plurality of coupon categories may also be based on other variables. These other variables include an ATM transaction type, an ATM transaction amount, a user's age, a user's gender, a user's prior purchases, etc. For example, if the user 126 withdraws a relatively low amount of cash (e.g., $20), a fast food restaurant category may be selected. In contrast, if the user 126 withdraws a relatively high amount of cash (e.g., $200), a fine dining restaurant category may be selected. In addition, complimentary categories and/or coupons may be selected. For example, if the user 126 is presented a coupon for shoes at one retail location 122, the user |1265| may also be presented a coupon for socks at the same retail location 122 and/or at a different retail location 122.

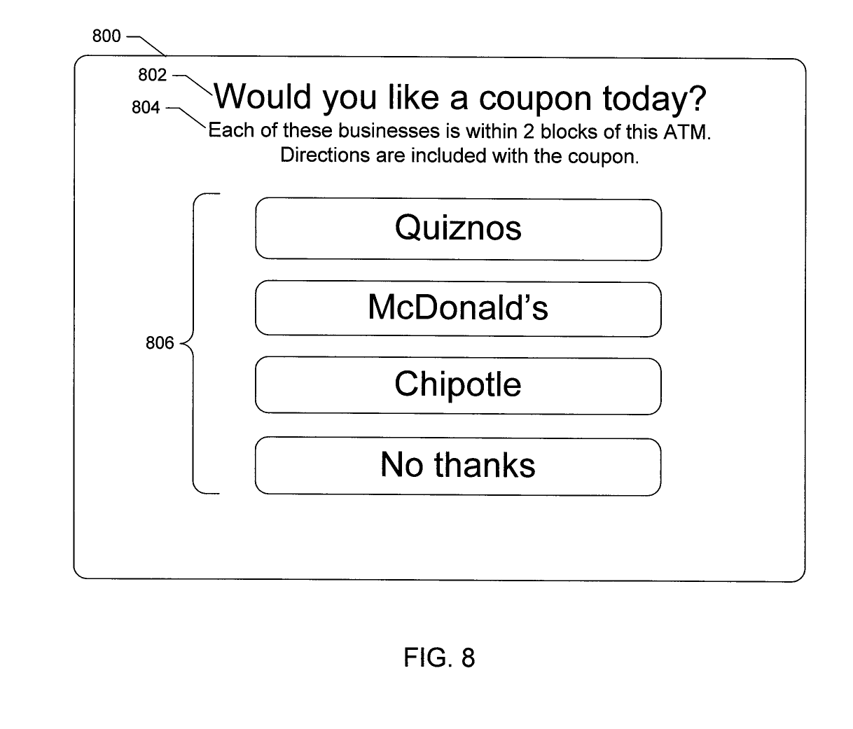

Once the coupon categories are selected, the ATM 102 preferably displays selections associated with the coupon categories (block 314). A screen shot of an example category selection screen 800 is illustrated in FIG. 8. In this example, the category selection screen 800 includes a text prompt 802, a proximity message 804, and a category selection area 806. The example text prompt 802 asks the user 102 if he/she would like to select a coupon. The example proximity message 804 indicates that the businesses listed in the category selection area 806 are each located within two blocks of the ATM 102 and that directions from the ATM 102 to the business selected will be included with the coupon. The example category selection area 806 includes a touch screen button to select a “Quiznos” category, a touch screen button to select a “McDonald's” category, a touch screen button to select a “Chipotle” category, and a touch screen button to indicate that the user 126 does not want a coupon. It will be appreciated that any suitable categories may be used. For example, the user 126 may be presented with a plurality of product or service types (e.g., lunch, coffee, etc.) instead of the names of the retailers. In addition, it will be appreciated that any suitable selection means may be used. For example, the user 126 may select a coupon category using a portable electronic device and/or a physical keyboard.

Once the ATM 102 receives the category selection (block 316), the ATM 102, the application server 106, the coupon server 108, and/or the map server 112 preferably select one or more coupons based on the category selection, the geographical area 104 associated with the ATM 102, and/or other variables (block 318). For example, if the user 126 selects the “Quiznos” category shown in FIG. 8, the ATM 102 or the coupon server 108 may select two Quiznos coupons from a coupon data structure 224. It will be appreciated that in some embodiments, the ATM 102 does not present the user 126 with a category selection. In such an instance, the coupon selection is not based on a category selection. In some embodiments, ATMs 102 located inside a retail location 122 may only show coupons for products sold by that retail location 122. Alternately, coupons for products within that retail location 122 may be displayed more prominently (e.g., bigger, higher in list, in color, etc), more often, at a different cost per click (higher or lower), etc.

In some embodiments, the coupon selection is based on a fee amount paid by the retailer associated with the coupon. For example, a Quiznos owner may pay an amount to advertise on certain ATMs 102 located near his/her store. In an embodiment, coupon providers may bid against each other for certain ATMs 102, geographic locations 104, categories, user demographics, etc. For example, a Quiznos owner may indicate he/she is willing to pay ten cents for each coupon printed between 11:00 AM and 1:00 PM to users 126 that withdrew at least $40 from any ATM 102 located within three blocks of his/her Quiznos location. Coupon providers (e.g., store owners, product manufactures, etc.) may be charged in a variety of different ways. For example, coupon providers may be charged for each time a coupon is displayed, each time a coupon is printed, and/or each time a coupon is redeemed. In an embodiment, coupon providers may be charged at various rates depending on certain coupon variables, such as the size and style of the coupon, the value of the coupon, etc. Optionally, coupon providers may indicate a maximum dollars to be charged in a given time period. When this maximum is reached, other provider coupons may be displayed.

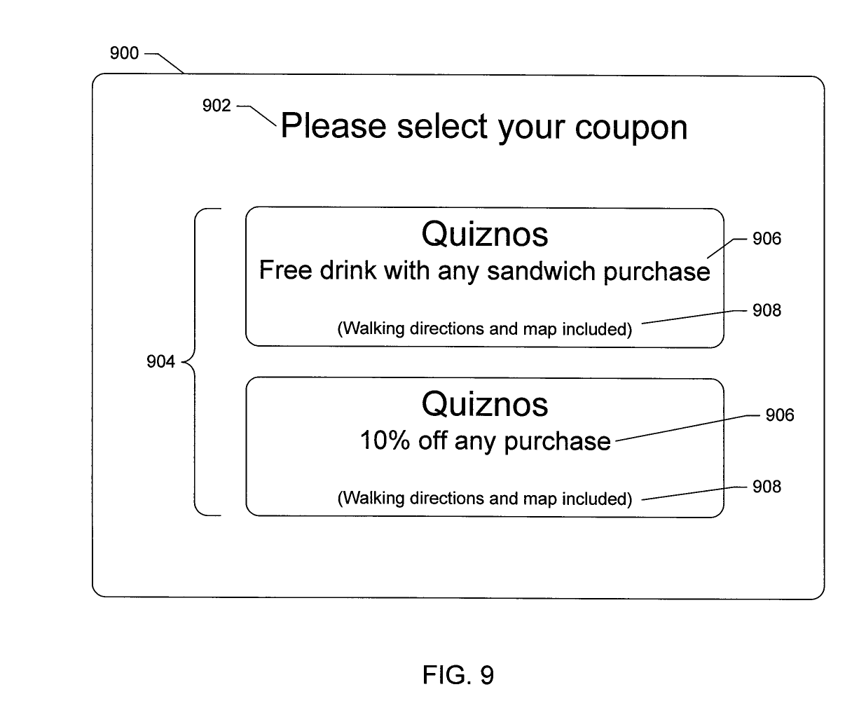

Once the coupon(s) are selected from the database, the ATM 102 preferably displays graphical representations of the coupon(s) on the ATM display 216 (block 320). A screen shot of an example coupon selection screen 900 is illustrated in FIG. 9. In this example, the coupon selection screen 900 includes a text prompt 902 and a coupon selection area 904. The example text prompt 902 asks the user 102 to select a coupon. In this example, the user 126 is given a choice of two Quiznos coupons. Each coupon indicates the terms 906 of the offer (e.g., 10% off) and that walking directions 908 and a map are included with the coupon. The user 126 then selects one of the displayed coupons in a well-known manner (block 322).

At some point during the processes 300, the ATM 102 retrieves maps, text-based directions, and/or video directions to the retail location associated with the selected coupon (block 324). For example, the ATM 102 may retrieve data from the map server 112 in real time, or the ATM 102 may retrieve local data that is periodically updated by the map server 112 as described below.

In an embodiment, the ATM 102 displays some or all of the retrieved maps, text-based directions, and/or video based directions on the ATM display 216 (block 326). Alternately, or in addition, the ATM 102 may transmit (e.g., wirelessly via Bluetooth or WiFi) some or all of the retrieved maps, text-based directions, and/or video based directions to a portable device, such as a wireless telephone and/or a personal digital assistant. Alternately, or in addition, the ATM 102 may transmit (e.g., wirelessly via Bluetooth or WiFi) data to program a Global Position System (GPS) in the portable device (e.g., the ATM location and/or the store location).

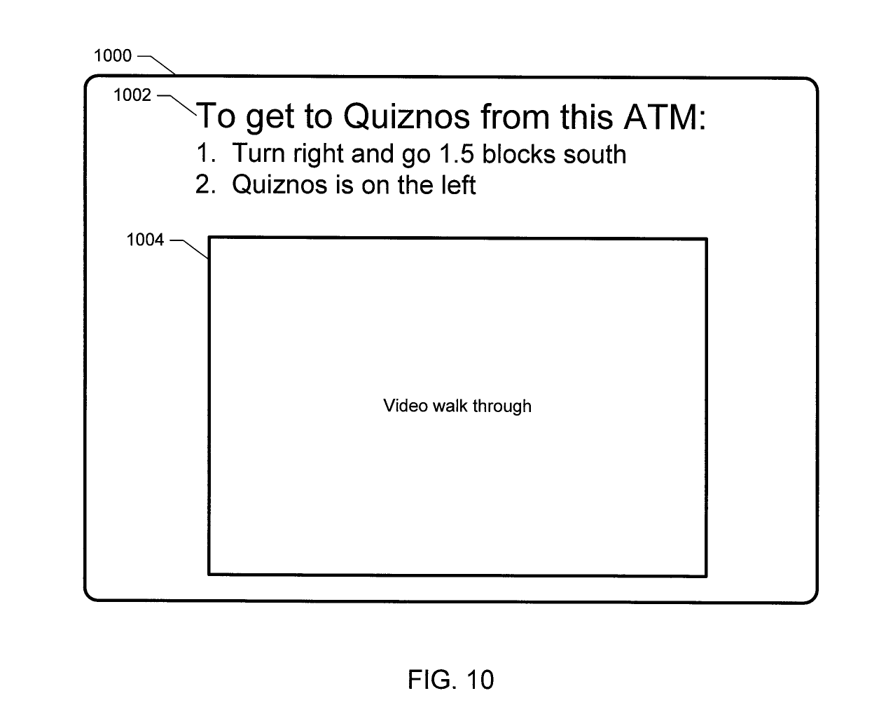

A screen shot of an example directions screen 1000 is illustrated in FIG. 10. The directions screen 1000 may be displayed on the ATM 102 and/or on a portable device. In this example, the directions screen 1000 includes text-based walking directions 1002 and a video walk through 1004. The example text-based walking directions 1002 instruct the user 126 how to get from the ATM 102 to the retail location 122. Alternately, or in addition, the text-based walking directions may instruct the user 126 how to get from the ATM 102 to an in-store location 118 (e.g., . . . go the end of aisle 5 . . . ). The example video walk through 1004 shows the user 126 what that walk will likely look like. In some embodiments, the maps, text-based directions, and/or video based directions include paid product placements. For example, the text-based directions may indicate that Quiznos is located “next to Starbucks” and/or a printed map for directions to Quiznos may include a Starbucks icon.

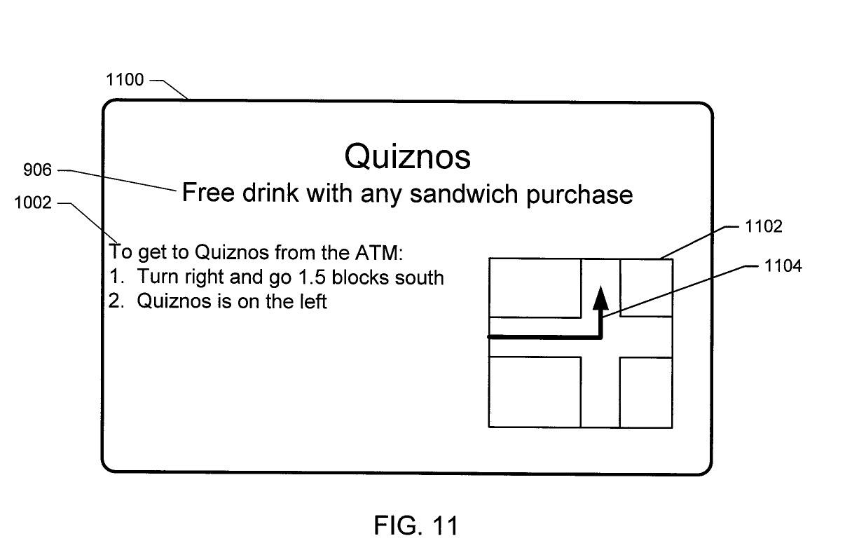

After the user 126 views the on-screen display of the retrieved maps, text-based directions, and/or video-based directions, the ATM 102 prints the requested coupon(s) (block 328). Alternatively, or in addition, the ATM 102 may transmit coupon data to the user's hand-held device (e.g., a cellular telephone). An example of a printed coupon 1100 is illustrated in FIG. 11. In this example, the printed coupon 1100 includes the terms 906 of the coupon 1100, the text-based walking directions 1002, and a map 1102 with an overlaid route 1104. Preferably, in-store maps include floor layouts and/or aisle numbers. Coupons may also include information about store specials.

As discussed above, coupon providers (e.g., retail store owners) are charged for this service of distributing their coupons (block 330). Again, coupon providers may be charged each time a coupon is displayed, each time a coupon is printed, and/or each time a coupon is redeemed.

Periodically, or in real time, the coupon server 108 provides the ATMs 102 with updated coupon data 224 and/or updated advertising data 226 (block 332). As described above, coupon data 224 may include coupon text, coupon graphics, coupon amounts, coupon codes, expiration dates, etc. Advertising data 226 may include advertising text, advertising graphics, advertising animations, advertising video, advertising audio, etc.

Similarly, the map server 112 periodically, or in real time, provides the ATMs 102 with updated geographic location data 232 and/or map data 234 (block 334). As described above, geographic location data 232 may include Global Positioning System (GPS) data, latitudes, longitudes, zip codes, area codes, cities, states, streets, addresses, etc. Map data 234 may include map text, map graphics, map animation, map video, map audio, etc.

In summary, persons of ordinary skill in the |art| will readily appreciate that methods and apparatus for providing a coupon at an automated teller machine have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

1. A method of producing a coupon, the method comprising:
receiving a user identifier at an automated teller machine, the automated teller machine being located at a first geographical location;
performing a monetary transaction at the automated teller machine;
selecting first data indicative of the coupon from second data indicative of a plurality of coupons, the coupon being associated with a business located at a second geographical location, the selection being based on third data indicative of the first geographical location and fourth data indicative of the second geographical location;
receiving fifth data indicative of directions from the first geographical location to the second geographical location; and
outputting the coupon from the automated teller machine, the coupon including the directions.

2. The method of claim 1, wherein receiving the user identifier includes a reading a magnetic strip located on a bank card.

3. The method of claim 1, wherein receiving the user identifier includes a wirelessly receiving the user identifier.

4. The method of claim 1, wherein receiving the user identifier includes reading biometric data associated with a person.

5. The method of claim 4, wherein reading the biometric data includes performing a fingerprint scan.

6. The method of claim 4, wherein reading the biometric data includes performing a retina scan.

7. The method of claim 1, wherein receiving the user identifier includes receiving a personal identification number (PIN).

8. The method of claim 1, wherein the second data indicative of the plurality of coupons is stored in the automated teller machine.

9. The method of claim 8, wherein the automated teller machine receives the second data indicative of the plurality of coupons via a wide area network.

10. The method of claim 1, wherein the second data indicative of the plurality of coupons is stored remotely from the automated teller machine, and the automated teller machine receives the first data indicative of the coupon via a wide area network.

11. The method of claim 1, wherein selecting the first data indicative of the coupon from the second data indicative of the plurality of coupons includes determining a distance between the first geographical location and the second geographical location.

12. The method of claim 1, wherein the fifth data indicative of the directions from the first geographical location to the second geographical location includes sixth data indicative of text-based walking directions.

13. The method of claim 1, wherein the fifth data indicative of the directions from the first geographical location to the second geographical location includes sixth data indicative of a graphical map.

14. The method of claim 13, wherein the fifth data indicative of the directions from the first geographical location to the second geographical location includes seventh data indicative of text-based walking directions.

15. The method of claim 1, wherein outputting the coupon from the automated teller machine includes printing the coupon.

16. The method of claim 1, wherein outputting the coupon from the automated teller machine includes wirelessly transmitting the coupon.

17. The method of claim 1, wherein outputting the coupon from the automated teller machine includes wirelessly transmitting Global Positioning System (GPS) data to a portable device.

18. The method of claim 1, including charging the business located at the second geographical location.

19. The method of claim 18, wherein charging the business includes charging the business based on a number of coupons that are displayed.

20. The method of claim 18, wherein charging the business includes charging the business based on a number of coupons that are printed.

21. The method of claim 18, wherein charging the business includes charging the business based on a number of coupons that are redeemed.

22. An apparatus for producing a coupon, the apparatus comprising:
a processor;
a display device operatively coupled to the processor;
a user input device operatively coupled to the processor; and
a memory device operatively coupled to the processor, the memory device storing software instructions to cause the processor to:
receive a user identifier at an automated teller machine, the automated teller machine being located at a first geographical location;
perform a monetary transaction at the automated teller machine;
select first data indicative of the coupon from second data indicative of a plurality of coupons, the coupon being associated with a business located at a second geographical location, the selection being based on third data indicative of the first geographical location and fourth data indicative of the second geographical location;
receive fifth data indicative of directions from the first geographical location to the second geographical location; and
output the coupon from the automated teller machine, the coupon including the directions.

23. The apparatus of claim 22, wherein the second data indicative of the plurality of coupons is stored remotely from the automated teller machine, and the automated teller machine receives the first data indicative of the coupon via a wide area network.

24. The apparatus of claim 22, wherein the software instructions are structured to cause the processor to select the first data indicative of the coupon from the second data indicative of the plurality of coupons includes determining a distance between the first geographical location and the second geographical location.

25. The apparatus of claim 22, wherein the fifth data indicative of the directions from the first geographical location to the second geographical location includes sixth data indicative of text-based walking directions.

26. The apparatus of claim 22, wherein the fifth data indicative of the directions from the first geographical location to the second geographical location includes sixth data indicative of a graphical map.

27. The apparatus of claim 26, wherein the fifth data indicative of the directions from the first geographical location to the second geographical location includes seventh data indicative of text-based walking directions.

28. The apparatus of claim 22, wherein the software instructions are structured to cause the processor to output the coupon from the automated teller machine by printing the coupon.

29. The apparatus of claim 22, wherein the software instructions are structured to cause the processor to output the coupon from the automated teller machine by wirelessly transmitting the coupon.

30. The apparatus of claim 22, wherein the software instructions are structured to cause the processor to charge the business located at the second geographical location based on at least one of (i) a number of coupons that are displayed, (ii) a number of coupons that are printed, and (iii) a number of coupons that are redeemed.

31. A computer readable medium storing software instructions to cause a computing device to:
receive a user identifier at an automated teller machine, the automated teller machine being located at a first geographical location;
perform a monetary transaction at the automated teller machine;
selecting first data indicative of the coupon from second data indicative of a plurality of coupons, the coupon being associated with a business located at a second geographical location, the selection being based on third data indicative of the first geographical location and fourth data indicative of the second geographical location;
receive fifth data indicative of directions from the first geographical location to the second geographical location; and
output the coupon from the automated teller machine, the coupon including the directions.
